(19) United States
(12) Patent Application Publication
(10) Pub. No.: US 2022/0365892 A1
(43) Pub. Date: Nov. 17, 2022

(54) Accelerating Method of Executing Comparison Functions and Accelerating System of Executing Comparison Functions

(71) Applicant: Realtek Semiconductor Corp., HsinChu (TW)

(72) Inventor: YUEFENG CHEN, Suzhou City (CN)

(73) Assignee: Realtek Semiconductor Corp., HsinChu (TW)

(21) Appl. No.: 17/524,674

(22) Filed: Nov. 11, 2021

(30) Foreign Application Priority Data
May 14, 2021 (CN) 202110528827.X

(51) Int. Cl. G06F 13/16

(52) U.S. Cl. CPC G06F 13/1673; G06F 13/1689

(57) ABSTRACT

An accelerating method includes inputting first data and second data, buffering the first data and the second data to at least one memory, acquiring a first address of the first data, acquiring a second address of the second data, generating a code corresponding to the comparison functions, combining the code, the first address, and the second address to form a command signal, transmitting the command signal from an advanced extensible interface to a bus circuit, reading out the first data and the second data from the at least one memory according to the first address and the second address, comparing the first data with the second data by using an accelerator, generating a comparison result of the first data and the second data, and transmitting the comparison result to the advanced extensible interface.

### BACKGROUND OF THE INVENTION

### 1. Field of the Invention

The present disclosure illustrates an accelerating method and an accelerating system, and more particularly, an accelerating method and an accelerating system of executing comparison functions by introducing additional hardware components.

### 2. Description of the Prior Art

With the rapid development of science and technology, programming languages and automated processing technologies are adopted in our daily life. The programming languages include library functions. Different library functions can execute different commands. For example, the C language has many functions for comparing strings, such as a strcmp function, a strchr function, a strlen function, and a strstr function.

In order to execute functions (i.e., such as “strchr”, “strlen”, and “strstr”), a compiler can be used for linking these functions with C language library. Then, in the C language library, a processor can read a string of a source address and a string of a destination address. Further, the processor can compare contents of the two strings according to lengths of bytes and words of the two strings.

In aforementioned methods of executing the functions of strcmp, strchr, strlen, and strstr, the long processing time and large transmission bandwidth are required. Therefore, for the processor, the long processing time and large transmission bandwidth occupy a lot of resources of the processor.

### SUMMARY OF THE INVENTION

In an embodiment of the present disclosure, an accelerating method of executing comparison functions is disclosed. The accelerating method comprises inputting first data and second data, buffering the first data and the second data to at least one memory, acquiring a first address of the first data, acquiring a second address of the second data, generating a code corresponding to the comparison functions, combining the code, the first address, and the second address to form a command signal, transmitting the command signal from an advanced extensible interface to a bus circuit, reading out the first data and the second data from the at least one memory according to the first address and the second address, comparing the first data with the second data by using an accelerator, generating a comparison result of the first data and the second data, and transmitting the comparison result to the advanced extensible interface.

In another embodiment of the present disclosure, an accelerating system of executing comparison functions is disclosed. The accelerating system comprises a processor, a bus circuit, and at least one memory. The processor comprises an advanced extensible interface and is configured to receive data and generate a command signal. The bus circuit is coupled to the advanced extensible interface and configured to receive the command signal. The at least one memory is coupled to the bus circuit and configured to buffer data. After first data and second data are inputted to the advanced extensible interface, the first data and the second data are buffered to the at least one memory. The processor acquires a first address of the first data and a second address of the second data. The processor generates a code corresponding to the comparison functions, and combines the code, the first address, and the second address to form a command signal. The processor transmits the command signal from the advanced extensible interface to the bus circuit. After the first data and the second data from the at least one memory are read out according to the first address and the second address, an accelerator compares the first data with the second data for generating a comparison result of the first data and the second data. The comparison result is transmitted to the advanced extensible interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an accelerating system of executing comparison functions according to a first embodiment of the present disclosure.

FIG. 2 is a block diagram of an accelerating system of executing comparison functions according to a second embodiment of the present disclosure.

FIG. 3 is a block diagram of an accelerating system of executing comparison functions according to a third embodiment of the present disclosure.

FIG. 4 is a block diagram of an accelerating system of executing comparison functions according to a fourth embodiment of the present disclosure.

FIG. 5 is a block diagram of an accelerating system of executing comparison functions according to a fifth embodiment of the present disclosure.

FIG. 6 is a flow chart of performing an accelerating method of executing comparison functions by using the accelerating system in FIG. 1.

### DETAILED DESCRIPTION

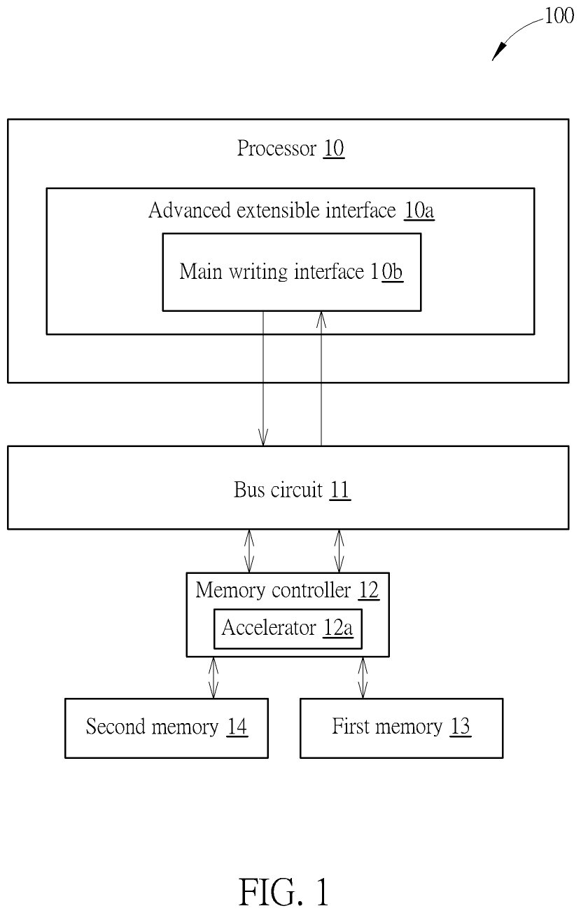

FIG. 1 is a block diagram of an accelerating system 100 of executing comparison functions according to a first embodiment of the present disclosure. Various embodiments are introduced in the accelerating system for accelerating processing speed of comparison functions of the programming language. These embodiments can also simplify commands and mitigate resources occupied in a queue of a processor. Details are illustrated later. The accelerating system 100 can include a processor 10, a bus circuit 11, and at least one memory (i.e., such a first memory 13 and a second memory 14). The processor 10 can include an advanced extensible interface 10a for receiving data and generating a command signal. The advanced extensible interface 10a includes a main writing interface 10b for communicating with the bus circuit 11. The bus circuit 11 is coupled to the advanced extensible interface 10a for receiving the command signal. The at least one memory is linked to the bus circuit 11 through a memory controller 12 for buffering data. For example, the first memory 13 and the second memory 14 can be two memory segments partitioned from one memory circuit. Alternatively, the first memory 13 and the second memory 14 can be two different circuits. The memory controller 12 can include an accelerator 12a. The first memory 13 and the second memory 14 are coupled to the memory controller 12. The first data buffered in the first memory 13 is compared with the second data buffered in the second memory 14 by using the accelerator 12a. Here, the first data and the second data can be any character string data or any digital data. The comparison functions of a program can be string comparison function of C program, such as a strcmp function, a strchr function, a strlen function, and a strstr function.

In the accelerating system 100, as previously mentioned, the first data and the second data can be buffered in the first memory 13 and the second memory 14 respectively. After the first data and the second data are inputted to the advanced extensible interface 10a by the processor 10, the processor 10 can acquire a first address of the first data and a second address of the second data. The processor 10 can generate a code corresponding to the comparison functions. Then, the processor 10 can combine the code, the first address, and the second address to form a command signal (i.e., a function command instruction). The processor 10 transmits the command signal from the advanced extensible interface 10a to the bus circuit 11. After the first data and the second data from the at least one memory are read out according to the first address and the second address, the accelerator 12a can compare the first data with the second data for generating a comparison result of the first data and the second data. Finally, the comparison result of the first data and the second data can be transmitted to the advanced extensible interface 10a.

In the accelerating system 100, some properties are introduced as follows. Extended instructions of the processor 10, logical operations of the extended instructions, extended part of the bus circuit 11 or the memory controller 12, and protocols of the processor 10, the bus circuit 11, and the memory controller 12 can be used for collaboratively executing the strcmp function, the strchr function, the strlen function, and the strstr function. Further, for the processor 10, commands of the strcmp function, the strchr function, the strlen function, and the strstr function can be extended as specific instructions. When the processor 10 executes the specific instructions, the processor 10 can generate command signals to the bus circuit 11 according to default register configurations. For example, for the advanced extensible interface 10a, the processor 10 can generate the specific instructions for requesting the bus circuit 11 to executing the strcmp function, the strchr function, the strlen function, and the strstr function. Further, after the bus circuit 11 or the memory controller 12 receives a special protocol request, it can cooperatively execute the strcmp function, the strchr function, the strlen function, and the strstr function. Finally, a result value or an interruption notification signal can be returned to the processor 10. Therefore, the accelerating system 100 has the following advantages. First, since additional hardware components (i.e., such as the bus circuit 11, the memory controller 12, and the accelerator 12a) are introduced for assisting the processor 10 to execute various functions such as the strcmp function, the strchr function, the strlen function, and the strstr function, resource requirements of the processor 10 can be reduced. Therefore, since more resources of the processor 10 can be released, the processor 10 can execute other programs without sacrificing a lot of processing time. Second, since the comparison function corresponds to specific instruction, its command can be simplified. Third, a data accessing path is generated between the memory controller 12 and at least one memory. Transmissions of returning the result value of the comparison result to the processor 10 (i.e., the memory controller 12 to the processor 10 through the bus circuit 11) only require a small bandwidth capacity. Any reasonable technology modification or hardware replacement should be covered by the scope of the present disclosure.

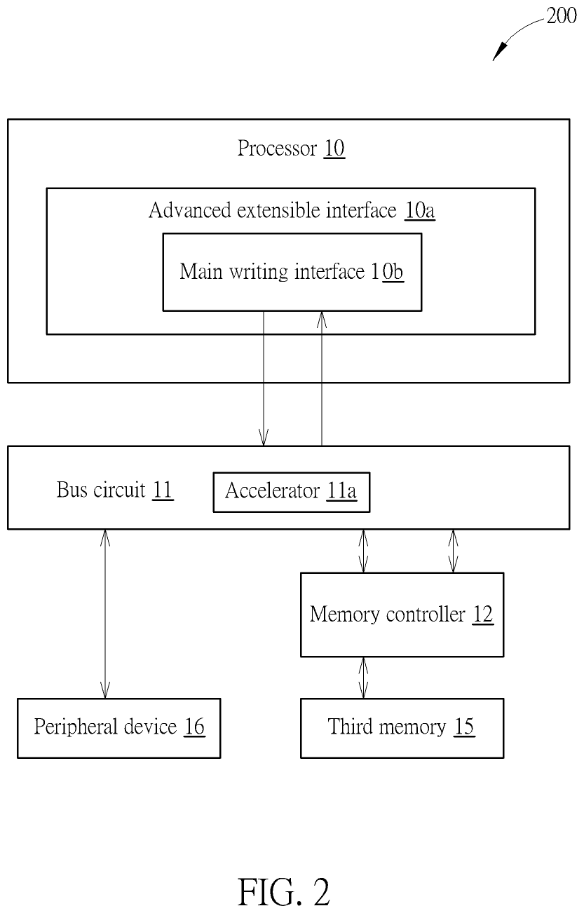

FIG. 2 is a block diagram of an accelerating system 200 of executing comparison functions according to a second embodiment of the present disclosure. In the accelerating system 200, the first data is buffered in a third memory 15. The second data is buffered in a peripheral device 16. Further, the accelerator 11a is disposed inside the bus circuit 11. The third memory 15 and the peripheral device 16 are coupled to the bus circuit 11. The accelerator 11a can be used for comparing the first data buffered in the third memory 15 and the second data buffered in the peripheral device 16. In the accelerating system 200, the bus circuit 11 can access the second data buffered in the peripheral device 16. The bus circuit 11 can also access the first data buffered in the third memory 15 through the memory controller 12. Therefore, the accelerator 11a can be disposed in the bus circuit 11 for executing various functions such as the strcmp function, the strchr function, the strlen function, and the strstr function. Finally, the result value of the comparison result can be transmitted to the processor 10 by the bus circuit 11. Therefore, the accelerating system 200 can be regarded as one embodiment with the processor 10 supported an extended bus protocol. Similarly, the accelerating system 200 has the following advantages. First, since additional hardware components (i.e., such as the bus circuit 11, the memory controller 12, and the accelerator 11a) are introduced for assisting the processor 10 to execute various functions such as the strcmp function, the strchr function, the strlen function, and the strstr function, resource requirements of the processor 10 can be reduced. Therefore, since more resources of the processor 10 can be released, the processor 10 can execute other programs without sacrificing a lot of processing time. Second, since the comparison function corresponds to specific instruction, its command can be simplified. Third, a data accessing path is generated between the memory controller 12 and at least one memory. Transmissions of returning the result value of the comparison result to the processor 10 (i.e., the bus circuit 11 to the processor 10) only require a small bandwidth capacity. Any reasonable technology modification or hardware replacement should be covered by the scope of the present disclosure.

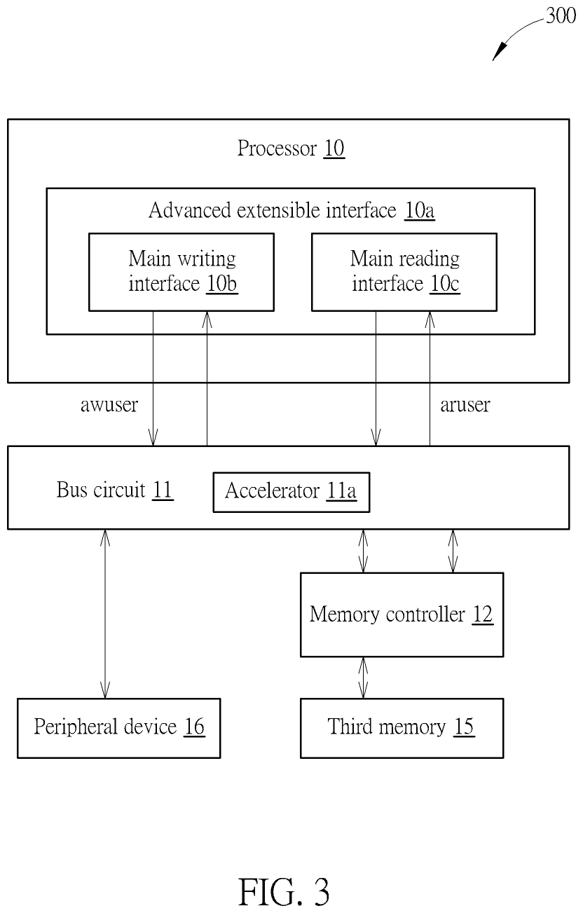

FIG. 3 is a block diagram of an accelerating system 300 of executing comparison functions according to a third embodiment of the present disclosure. In the accelerating system 300, the advanced extensible interface 10a further includes a main reading interface 10c. The main reading interface 10c in the advanced expandable interface 10a is also connected to the bus circuit 11. Therefore, the main reading interface 10c in the advanced expandable interface 10a can also perform bi-directional communications with the bus circuit 11. For example, the main reading interface 10c in the advanced expandable interface 10a can transmit a command signal to the bus circuit 11. Further, the bus circuit 11 may also transmit a comparison result to the processor 10. In other words, in the accelerating system 300, a write user (awuser) channel can be used for communicating a main writing interface 10b in the advanced extensible interface 10a with the bus circuit 11. A read user (aruser) channel can also be used for communicating a main reading interface 10c with the bus circuit 11. Therefore, operating modes of the awuser and the aruser are similar. The advanced extensible interface 10a can support both awuser command sets and aruser command sets.

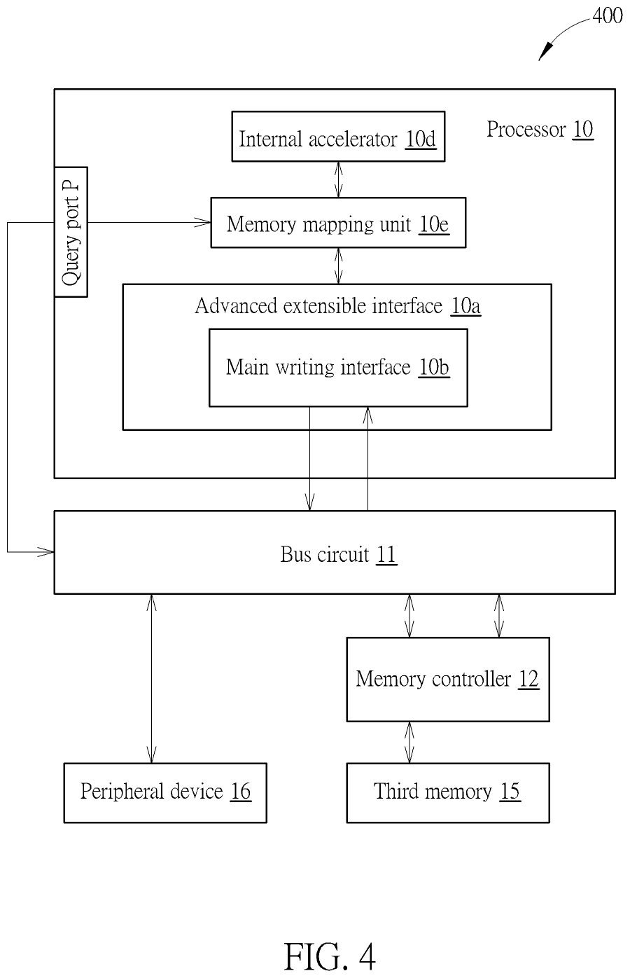

FIG. 4 is a block diagram of an accelerating system 400 of executing comparison functions according to a fourth embodiment of the present disclosure. The accelerating system 400 can also introduce an internal accelerator 10d, a memory mapping unit 10e, and a query port P. The processor 10 can use the internal accelerator 10d for driving the memory mapping unit 10e for converting formats of the first address and the second address from two virtual address formats to two physical address formats. The first address and the second address having physical address formats are partitioned into a plurality of pages having fixed bit lengths. For example, the processor 10 may set 4K bytes as a page length. Pair-wised pages are adjacent. Therefore, if a length of the physical address is not an integer multiple of 4K bytes, the length of the physical address may exceed a certain page boundary. Therefore, memory coordinates of the physical address may be shifted. Therefore, in order to control the bus circuit 11 or the memory controller 12 to precisely acquire correct memory coordinates of the two physical addresses, the query port P can be introduced between the bus circuit 11 and the memory mapping unit 10e. Therefore, in the accelerating system 400, the processor 10 can use the query port P for synchronously accessing the first address and the second address having physical address formats generated by the memory mapping unit 10e to the bus circuit 11. Therefore, the accelerator (not shown) disposed inside the bus circuit 11 or the accelerator (not shown) disposed inside the memory controller 12 can acquire the first data and the second data according to the first address and the second address. Subsequent processes are similar to the modes of aforementioned embodiments. Therefore, they are omitted here.

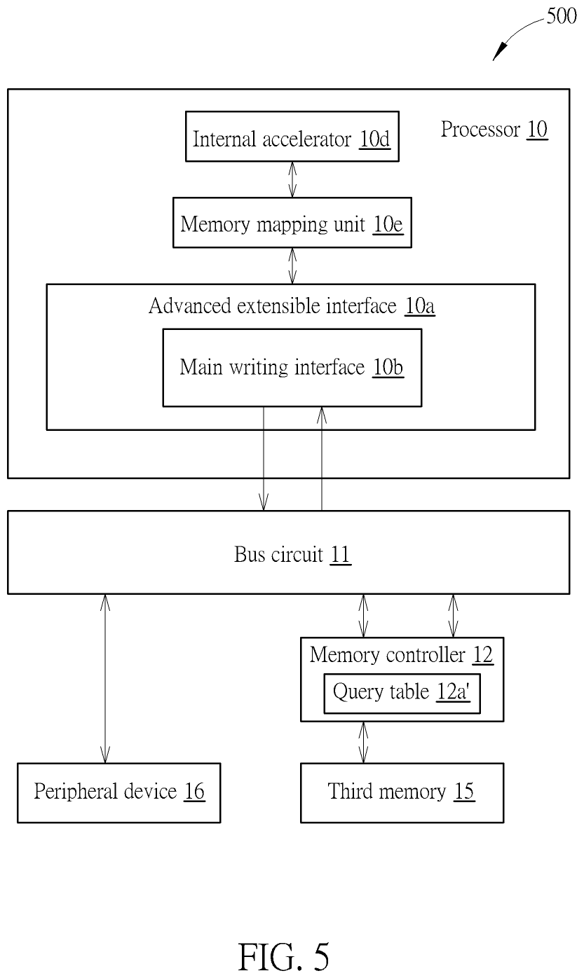

FIG. 5 is a block diagram of an accelerating system 500 of executing comparison functions according to a fifth embodiment of the present disclosure. The accelerating system 500 is similar to the accelerating system 400. A difference is that the memory controller 12 of the accelerating system 500 can include a query table 12a′. As previously mentioned, The processor 10 can use the internal accelerator 10d for driving the memory mapping unit 10e for converting formats of the first address and the second address from two virtual address formats to two physical address formats. Therefore, in order to control the memory controller 12 to precisely acquire the correct memory coordinates of the two physical addresses, the query table 12a′ can be introduced to the memory controller 12. Therefore, the processor 10 can read the first data and the second data by using the query table 12a′ of the memory controller 12 coupled to or disposed inside the bus circuit 11 according to the physical address formats of the first address and the second address. Finally, the bus circuit 11 can transmit the comparison results to the processor 10.

In the aforementioned embodiments of the accelerating systems, the bus circuit 11 or the memory controller 12 can be used for assisting the processor 10 to execute functions such as the strcmp function, the strchr function, the strlen function, and the strstr function. In practice, first, the processor 10 can receive the command and determine if it is a comparison function (i.e., for example, the strcmp function). If the command is not the comparison function, the processor 10 continuously receives a signal. If the command is the comparison function, the processor 10 waits for the corresponding write data (i.e., such as string data), or collects all required messages. Then, the processor 10 can read values of the two strings and compare the two strings (i.e., this step can be completed by an external circuit, such as the accelerator in the bus circuit 11 or the accelerator in the memory controller 12). Finally, after all characters are completely compared, the comparison result can be generated and transmitted to the processor 10 through the bus circuit 11. In other words, since the accelerating system of the present disclosure introduces additional hardware components such as the bus circuit 11 and/or the memory controller 12, the bus circuit 11 and/or the memory controller 12 can be used for assisting the processor 10 for comparing data of two strings. Therefore, the resources occupied in the queue of the processor can be mitigated. The processor 10 has more resources to execute other programs.

In practical programming operation, for avoiding ambiguity, an embodiment is introduced for executing the strcmp function, as illustrated below. Variables are defined as follows:

rs1: denoted as the address of the first string.
rs2: denoted as the address of the second string.
rs3: denoted as the length of the first string.

When the processor 10 executes instructions such as the Advanced Reduced Instruction Set Computer-Fifth (RISC-V) architecture, the information of the instructions can be converted into instructions supported by the bus circuit 11. For the Advanced Extensible Interface bus, some methods can be used for realizing the architecture. In a first method, when the processor 10 executes a special instruction, the processor 10 can generate a write command comprising “awaddr=source address” (i.e., data of rs1, which denotes the address of the first string), “awlen=burst length” (i.e., the length of the first string), and “awsize=1” (byte). At the same time, a command of “awvalid=1” is transmitted to the bus circuit 11. A message of data writing channel is also transmitted to the bus circuit 11. The message of the data writing channel includes wdata (i.e., data of rs2, which is the address of the second string), wstrb (i.e., masked bits of the byte), and identification code. As in previously embodiments, the write command can also be the read command. The write command can be extended by other signals for transmitting other information, such as the address of the second string. The processor 10 can control timing of transmitting the write command. For example, when the processor 10 is used for transmitting the command and the bus circuit 11 is operated in an idle state, the command can be transmitted from the bus circuit 11 immediately. Otherwise, the command may be queued until the processor 10 is available. Further, the processor 10 can execute other advanced extensible interface instructions without waiting for a return signal of the strcmp command. Moreover, when the writing mode of the advanced and expandable interface is executed, the bus circuit 11 can return a message of the comparison result to the processor 10. After the bus circuit 11 receives the write command and the write data, two addresses and lengths of the write command and the write data can be stored. The bus circuit 11 can generate two read commands to a slave device (i.e., for example, the memory controller 12). If two character strings do not correspond to the same slave device, the bus circuit 11 can also sequentially transmit two read commands for generating a comparison result of two data strings.

During a period of executing the strcmp function by the bus circuit 11, if the length of the string is greater than a maximum acceptable length, the string can be partitioned into several sub-strings for multiple transmissions. The processor 10 can record data of the source and destination addresses of each transmission until transmission of all sub-strings is done. In a second method, an extension part of the processor 10 and an extension part of the advanced extensible interface 10a are the same. The slave device (i.e., for example, the memory controller 12) can be used for executing the strcmp/strchr/strlen/strstr functions. A limitation of this method is that the data of strcmp/strchr/strlen/strstr functions is located (saved) under one device (i.e., the first memory 13 and/or the second memory 14 under the memory controller 12). It is assumed that the slave device is the memory controller 12. The memory controller 12 can store two addresses and two lengths after the memory controller 12 receives special commands and the string data. Then, the memory controller 12 can issue a read command to at least one memory and compare the two data strings when receiving the two data strings. In a third mode, the processor 10 is not modified. The bus circuit 11 or the memory controller 12 can directly execute the comparison functions. The processor 10 can set start timing and addresses of comparison operation, and acquire a flag of end timing of the comparison operation. For example, assume that the bus circuit 11 has a plurality of registers (not shown) for storing data and controlling data. The processor 10 can set a first register in the bus circuit 11 pointing to the first address of the first string. The processor 10 can set a second register in the bus circuit 11 pointing to the second address of the second string. The processor 10 can set a length of a third register in the bus circuit 11 for indicating the lengths of the two strings. However, if the end of the string is determined by the bus circuit 11, the third register can be omitted. The processor 10 can set a fourth register in the bus circuit 11 as an activation control unit. After the activation control unit of the fourth register is enabled, the processor 10 can read status information of a fifth register. It is assumed that after the operation of the bus circuit 11 is completed, a value “1” can be returned to the processor 10. After the processor 10 reads the value “1”, it can determine that the function operation has been completed. In the present disclosure, the comparison functions are string comparison functions executed by C programming language. The command signal can correspond to a processor extension command of the comparison functions. Any reasonable operation or hardware modification should be covered by the scope of the present disclosure.

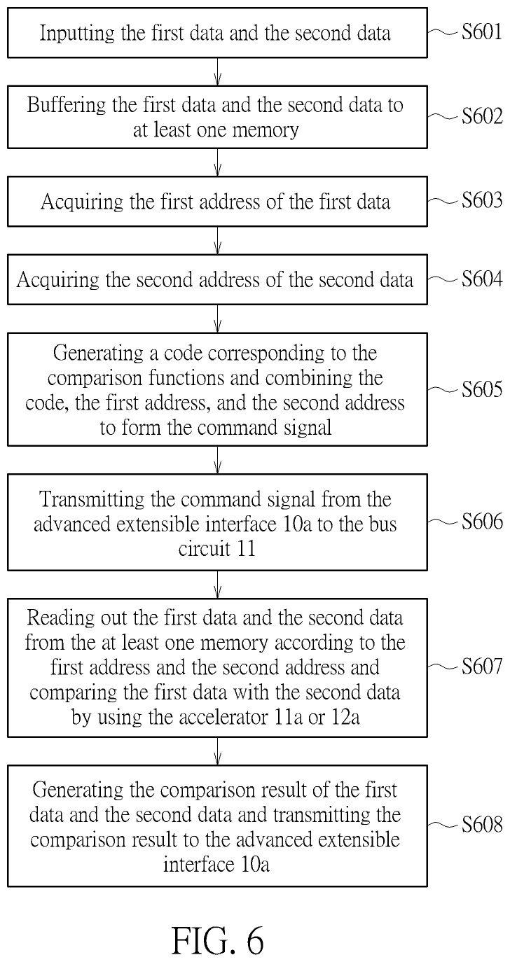

FIG. 6 is a flow chart of performing an accelerating method of executing comparison functions by using the accelerating systems 100-500. The accelerating method can include steps S601-S608. Any reasonable technology modification falls into the scope of the present disclosure. Steps S601-S608 are illustrated below.
Step S601: inputting the first data and the second data;
Step S602: buffering the first data and the second data to at least one memory;
Step S603: acquiring the first address of the first data;
Step S604: acquiring the second address of the second data;
Step S605: generating a code corresponding to the comparison functions and combining the code, the first address, and the second address to form the command signal;
Step S606: transmitting the command signal from the advanced extensible interface 10a to the bus circuit 11;
Step S607: reading out the first data and the second data from the at least one memory according to the first address and the second address and comparing the first data with the second data by using the accelerator 11a or 12a;
Step S608: generating the comparison result of the first data and the second data and transmitting the comparison result to the advanced extensible interface 10a.

Details of steps S601-S608 are previously illustrated. Thus, they are omitted here. In the accelerating system of the present disclosure, particular extended instructions of the processor 10 (i.e., corresponding to the bus circuit 11 and/or memory controller 12) and additional hardware components are introduced. Therefore, when the processor 10 prepares to perform comparison functions such as the strcmp/strchr/strlen/strstr function, the processor 10 can use extended instructions to control the bus circuit 11 and/or the memory controller 12 for assisting the processor 10 to process the comparison functions. Therefore, for the processor 10, the processing time and resource requirement can be reduced. No additional cache memory of the processor 10 is required. Therefore, the processor 10 has more resources to execute other programs.

To sum up, the present disclosure illustrates a method and a system for accelerating the execution of the comparison functions. The system can perform fast and high-efficiency operations of strcmp/strchr/strlen/strstr functions in specific programming languages (i.e., such as C language). Since the system of the present disclosure introduces additional hardware components such as a bus circuit or a memory controller, the hardware components such as the bus circuit or the memory controller can assist the processor for comparing data of two strings. Therefore, the resources occupied in the queue of the processor can be mitigated. The processor has more resources to execute other programs. Further, the system requires only a small amount of bandwidth for performing comparison functions. Therefore, the system of the present disclosure can accelerate execution speed of the comparison functions in conjunction with simplifying instructions and mitigating occupied resources of the processor.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An accelerating method of executing comparison functions comprising:
inputting first data and second data;
buffering the first data and the second data to at least one memory;
acquiring a first address of the first data;
acquiring a second address of the second data;
generating a code corresponding to the comparison functions;
combining the code, the first address, and the second address to form a command signal;
transmitting the command signal from an advanced extensible interface to a bus circuit;
reading out the first data and the second data from the at least one memory according to the first address and the second address;
comparing the first data with the second data by using an accelerator;
generating a comparison result of the first data and the second data; and
transmitting the comparison result to the advanced extensible interface.

2. The method of claim 1, wherein buffering the first data and the second data to the at least one memory includes buffering the first data to a first memory of the at least one memory and buffering the second data to a second memory of the at least one memory.

3. The method of claim 2, wherein the accelerator is disposed inside a memory controller, the first memory and the second memory are coupled to the memory controller, and comparing the first data with the second data by using the accelerator is comparing the first data buffered in the first memory with the second data buffered in the second memory by using the accelerator.

4. The method of claim 3, wherein transmitting the comparison result to the advanced extensible interface comprises:
transmitting the comparison result from the memory controller to the bus circuit for relaying the comparison result from the bus circuit to the advanced extensible interface.

5. The method of claim 1, wherein buffering the first data and the second data to the at least one memory is buffering the first data to a third memory of the at least one memory, and buffering the second data to a peripheral device.

6. The method of claim 5, wherein the accelerator is disposed inside the bus circuit, the third memory and the peripheral device are coupled to the bus circuit, and comparing the first data with the second data by using the accelerator is comparing the first data buffered in the third memory with the second data buffered in the peripheral device by using the accelerator.

7. The method of claim 1, further comprising:
driving a memory mapping unit by an internal accelerator for converting formats of the first address and the second address from two virtual address formats to two physical address formats; and
using a query port for synchronously accessing the first address and the second address having physical address formats generated by the memory mapping unit to the bus circuit;
wherein the first address and the second address having physical address formats are partitioned into a plurality of pages having fixed bit lengths.

8. The method of claim 1, further comprising:
driving a memory mapping unit by an internal accelerator for converting formats of the first address and the second address from two virtual address formats to two physical address formats; and
reading the first data and the second data by using a query table of a memory controller coupled to the bus circuit according to the physical address formats of the first address and the second address.

9. The method of claim 1, wherein the comparison functions are string comparison functions executed by C programming language, and the command signal corresponds a processor extension command of the comparison functions.

10. The method of claim 1, wherein the advanced extensible interface supports a read user channel and a write user channel.

11. An accelerating system of executing comparison functions comprising:
a processor comprising an advanced extensible interface and configured to receive data and generate a command signal;
a bus circuit coupled to the advanced extensible interface and configured to receive the command signal; and
at least one memory coupled to the bus circuit and configured to buffer data;
wherein after first data and second data are inputted to the advanced extensible interface, the first data and the second data are buffered to the at least one memory, the processor acquires a first address of the first data and a second address of the second data, generates a code corresponding to the comparison functions, and combines the code, the first address, and the second address to form a command signal, the processor transmits the command signal from the advanced extensible interface to the bus circuit, and after the first data and the second data from the at least one memory are read out according to the first address and the second address, an accelerator compares the first data with the second data for generating a comparison result of the first data and the second data, and transmits the comparison result to the advanced extensible interface.

12. The system of claim 11, wherein the first data is buffered in a first memory of the at least one memory, and the second data is buffered in a second memory of the at least one memory.

13. The system of claim 12, wherein the accelerator is disposed inside a memory controller, the first memory and the second memory are coupled to the memory controller, and the first data buffered in the first memory is compared with the second data buffered in the second memory by using the accelerator.

14. The system of claim 13, wherein the memory controller transmits the comparison result to the bus circuit for relaying the comparison result from the bus circuit to the advanced extensible interface.

15. The system of claim 11, wherein the first data is buffered in a third memory of the at least one memory, and the second data is buffered in a peripheral device.

16. The system of claim 15, wherein the accelerator is disposed inside the bus circuit, the third memory and the peripheral device are coupled to the bus circuit, and the first data buffered in the third memory is compared with the second data buffered in the peripheral device by using the accelerator.

17. The system of claim 11, wherein an internal accelerator disposed inside the processor is configured to drive a memory mapping unit disposed inside the processor for converting formats of the first address and the second address from two virtual address formats to two physical address formats, and the processor uses a query port for synchronously accessing the first address and the second address having physical address formats generated by the memory mapping unit to the bus circuit, and the first address and the second address having physical address formats are partitioned into a plurality of pages having fixed bit lengths.

18. The system of claim 11, wherein an internal accelerator disposed inside the processor is configured to drive a memory mapping unit disposed inside the processor for converting formats of the first address and the second address from two virtual address formats to two physical address formats, and the processor reads the first data and the second data by using a query table of a memory controller coupled to the bus circuit according to the physical address formats of the first address and the second address.

19. The system of claim 11, wherein the comparison functions are string comparison functions executed by C programming language, and the command signal corresponds a processor extension command of the comparison functions.

20. The system of claim 11, wherein the advanced extensible interface supports a read user channel and a write user channel.
